(19) United States
(12) Patent Application Publication
(10) Pub. No.: US 2015/0138448 A1
(43) Pub. Date: May 21, 2015

(54) Adjustable Display System for Vehicular Use

(71) Applicant: ATIEVA, INC., Redwood City, CA (US)

(72) Inventors: Peter Dore Rawlinson, Worcestershire (GB); Eric Obers, Rutesheim (DE)

(73) Assignee: ATIEVA, INC., Redwood City, CA (US)

(21) Appl. No.: 14/082,495

(22) Filed: Nov. 18, 2013

Related U.S. Application Data
(63) Continuation-in-part of application No. 14/082,241, filed on Nov. 18, 2013.

(51) Int. Cl. H04N 21/414; H04N 21/422; H04N 5/655

(52) U.S. Cl. CPC H04N 21/41422; H04N 5/655; H04N 21/42201
USPC 348/837

(57) ABSTRACT

An adjustable display screen mounted within a vehicle is provided. The combination of the display's mounting system and the linkage assembly allows the user to adjust and optimize the position of the display screen regardless of seating position, thereby alleviating the eye strain, fatigue, neck and back pain that often accompany the improper use of a monitor for an extended period of time.

### CROSS-REFERENCE TO RELATED APPLICATION

This application is a continuation-in-part of U.S. patent application Ser. No. 14/082,241, filed 18 Nov. 2013, the disclosure of which is incorporated herein by reference for any and all purposes.

### FIELD OF THE INVENTION

The present invention relates generally to display systems and, more particularly, to an adjustable display system for use in a vehicle.

### BACKGROUND OF THE INVENTION

The use of a laptop computer no longer requires that the user compromise on processor speed, display size, display resolution or memory. Additionally, given the battery life available in many such computers, the user is no longer required to limit their use to small working sessions. As a result, laptops have become a viable alternative for many professionals, offering the end user both the performance that they have come to expect from a desktop computer as well as the portability and convenience associated with a laptop. Unfortunately while the performance of laptop computers have improved dramatically over the last decade, their usefulness is still limited due to the setting in which they are often used. For example, on an airplane if the user does not wish to rest their computer on their lap, then they must sit their laptop on the tray table that is either linked to the back of the seat in front of their own, or linked to the arm-rest of their own chair. In a car the user's options are even more limited, in general requiring that the user either rest their computer directly on their lap or on a lap tray. Unfortunately, none of these approaches provide the user with a reasonable ergonomic solution, either in terms of display or keyboard position. Accordingly, what is needed is a system that allows a person to comfortably and ergonomically work while riding in a vehicle. The present invention provides such a system.

### SUMMARY OF THE INVENTION

The present invention provides an adjustable display system that includes (i) a guide track mounted within and to a vehicle, (ii) a linkage assembly that is slidably coupled to the guide track, where a first portion of the linkage assembly slides within the guide track and is adjustable within a range of positions, and (iii) a display coupled to a second portion of the linkage assembly. The side portion of the display or a center portion of the rear display panel may be coupled to the second portion of the linkage assembly. The first portion of the linkage assembly may be hingeably coupled to the guide track and configured to be adjustable and to pivot about an axis formed by the juncture of the first portion of the linkage assembly and the guide track. The second portion of the linkage assembly may be hingeably coupled to the display and configured to be adjustable and to pivot about an axis formed by the juncture of the first portion of the linkage assembly and the display.

In one aspect, the linkage assembly may be comprised of a first arm and a second arm, where the first portion of the linkage assembly is comprised of a first end portion of the first arm and a first end portion of the second arm, and where the second portion of the linkage assembly is comprised of a second end portion of the first arm and a second end portion of the second arm. The first end portion of the first arm may be hingeably coupled to the guide track and configured to be adjustable and to pivot about a first axis formed by the juncture of the first end portion of the first arm and the guide track, and the first end portion of the second arm may be hingeably coupled to the guide track and configured to be adjustable and to pivot about a second axis formed by the juncture of the first end portion of the second arm and the guide track. The second end portion of the first arm may be hingeably coupled to the display and configured to be adjustable and to pivot about a first axis formed by the juncture of the second end portion of the first arm and the display, and the second end portion of the second arm may be hingeably coupled to the display and configured to be adjustable and to pivot about a second axis formed by the juncture of the second end portion of the second arm and the display.

In another aspect, the linkage assembly may be comprised of a telescoping link, where the length of the link is adjustable and controls the separation distance between the guide track and the display.

In another aspect, the linkage assembly may be comprised of a first arm and a second arm, where the first portion of the linkage assembly is comprised of a first end portion of the first arm, where the second end portion of the first arm is hingeably coupled to the first end portion of the second arm and is configured to be adjustable and to pivot about a first axis formed by the juncture of the second end portion of the first arm and the first end portion of the second arm, and where the second portion of the linkage assembly is comprised of the second end portion of the second arm. The first end portion of the first arm may be hingeably coupled to the guide track and configured to be adjustable and to pivot about a second axis formed by the juncture of the first end portion of the first arm and the guide track. The second end portion of the second arm may be hingeably coupled to the display and configured to be adjustable and to pivot about a second axis formed by the juncture of the second end portion of the second arm and the display.

In another aspect, the system may further include a second guide track mounted within and to the vehicle and a second linkage assembly that is slidably coupled to the second guide track, where a first portion of the second linkage assembly slides within the second guide track and is adjustable within a range of positions, and where the display is coupled to a second portion of the second linkage assembly.

In another aspect, the system may further include a user interface and a positioning system (e.g., an electro-mechanical positioning system, a hydraulic positioning system, etc.) where the positioning system is coupled to the linkage assembly. The user interface is configured to accept display movement instructions and the positioning system is configured to move the display using the linkage assembly in response to the display movement instructions input via the user interface. A controller may be coupled to the positioning system and a vehicle status monitor may be coupled to the controller, where the vehicle status monitor outputs a display deployment signal upon detection of a first vehicle status (e.g., activation of the vehicle) and outputs a display storage signal upon detection of a second vehicle status (e.g., de-activation of the vehicle, vehicle being placed in park), and where the controller deploys the display using the positioning system upon receipt of the display deployment signal and positions the display in a storage position using the positioning system upon receipt of the display storage signal. A video source may be coupled to the display, where a controller coupled to the positioning system and to the video source deploys the display when the video source is activated and positions the display in a storage position when the video source is de-activated. A controller may be coupled to the positioning system and to the display, where the controller deploys the display when the display is activated and positions the display in the storage position when the display is de-activated.

A further understanding of the nature and advantages of the present invention may be realized by reference to the remaining portions of the specification and the drawings.

### BRIEF DESCRIPTION OF THE DRAWINGS

FIG. 1 provides a side view of an embodiment of the invention with the display stored;

FIG. 2 provides a side view of the adjustable display shown in FIG. 1 with the display positioned for use with a generally upright seat;

FIG. 3 provides a side view of the adjustable display shown in FIGS. 1 and 2 with the display re-positioned for use with a partially reclining seat;

FIG. 4 provides a side view of the adjustable display shown in FIGS. 1-3 with the display re-positioned for use with a fully reclining seat;

FIG. 5 provides a side view of the adjustable display shown in FIGS. 1-4 that illustrates re-positioning the display as the seat is moved backwards;

FIG. 6 provides a side view of the adjustable display shown in FIGS. 1-5 that illustrates re-positioning the display as the seat is lowered;

FIG. 7 illustrates the display characteristics of viewing distance, height and angle;

FIG. 8 illustrates the primary components of a manually operated system in accordance with the invention;

FIG. 9 illustrates a modification of the system shown in FIG. 8 which includes a use controlled display positioning system;

FIG. 10 illustrates a modification of the system shown in FIG. 9 which includes a system controller;

FIG. 11 provides a side view of an alternate embodiment of the invention with the display stored;

FIG. 12 provides a side view of the adjustable display shown in FIG. 11 with the display positioned for use with a generally upright seat;

FIG. 13 provides a side view of the adjustable display shown in FIGS. 11 and 12 with the display re-positioned for use with a partially reclining seat;

FIG. 14 provides a side view of the adjustable display shown in FIGS. 11-13 with the display re-positioned for use with a fully reclining seat;

FIG. 15 provides a side view of an alternate embodiment of the invention with the display stored;

FIG. 16 provides a side view of the adjustable display shown in FIG. 15 with the display positioned for use with a generally upright seat;

FIG. 17 provides a side view of the adjustable display shown in FIGS. 15 and 16 with the display re-positioned for use with a partially reclining seat;

FIG. 18 provides a side view of the adjustable display shown in FIGS. 15-17 with the display re-positioned for use with a fully reclining seat;

FIG. 19 provides a perspective view of an adjustable display attached to a single guide track via a single, centrally located linkage arm;

FIG. 20 provides a perspective view of an adjustable display attached to a single guide track via a pair of centrally located linkage arms;

FIG. 21 provides a perspective view of an adjustable display attached to a pair of guide tracks via a pair of side mounted linkage arms;

FIG. 22 provides a perspective view of an adjustable display attached to a pair of guide tracks via a first pair and a second pair of side mounted linkage arms;

FIG. 23 provides a perspective view of an adjustable display attached to a single guide track via a single, side mounted linkage arm; and

FIG. 24 provides a perspective view of an adjustable display attached to a single guide track via a pair of side mounted linkage arms.

### DESCRIPTION OF THE SPECIFIC EMBODIMENTS

The present invention provides an adjustable display screen mounted within a vehicle such as a car, bus, train or airplane. The system allows the user to adjust and optimize the position of the display screen regardless of seating position, thereby alleviating the eye strain, fatigue, neck and back pain that often accompany the improper use of a monitor for an extended period of time.

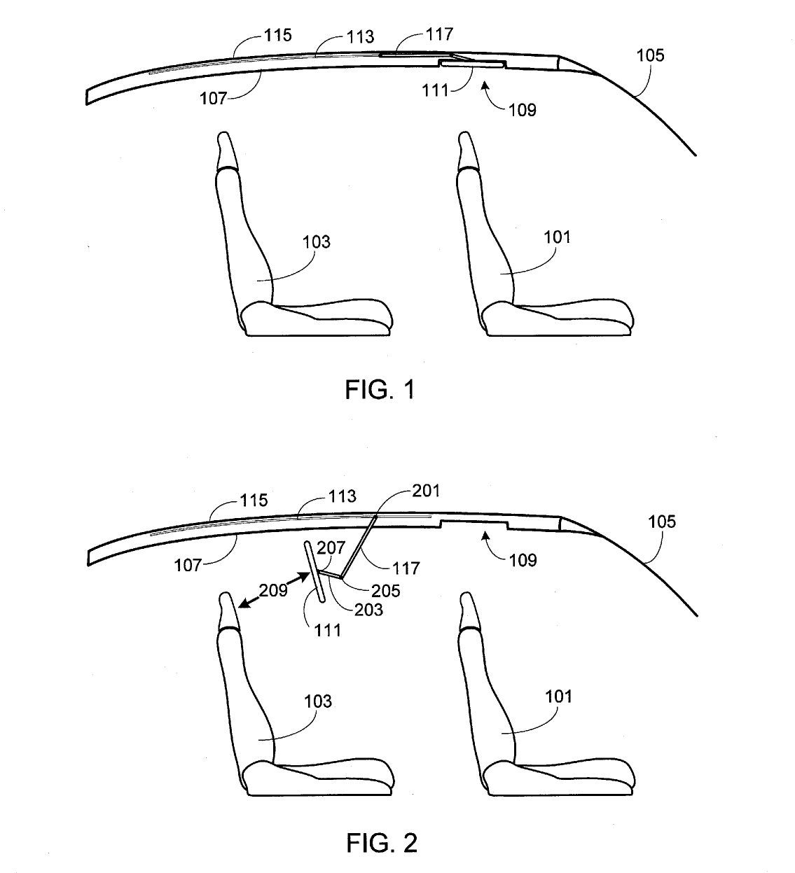

FIGS. 1-7 illustrate a preferred embodiment of the invention. FIG. 1 provides a side view of the primary vehicle components involved in a system utilizing the adjustable display of the invention. Visible in this figure is a front seat 101, a rear seat 103, the front windshield 105 and the vehicle's roof headliner 107. Stored within a recess 109 of the headliner is a display 111, although it should be understood that display 111 may be stored in other locations such as adjacent to the headliner but not within the headliner, adjacent to the sunroof, adjacent to the sunroof and within the sunroof pocket, in the rear deck, or elsewhere. In this embodiment display 111 is linked to a guide track 113 via linkage 117, track 113 preferably hidden from sight by locating it between the headliner 107 and the roof 115. Display linkage 117 preferably passes through a slot or slots in headliner 107.

As described in more detail below, in at least one embodiment display 111 is moved by the user manually gripping the display (or gripping a handle or handles coupled to the display) and moving display 111 to the desired location. In at least one alternate embodiment, a mechanical, electro-mechanical, or hydraulic positioning mechanism is coupled to display 111 and the display linkage, thus allowing the user to re-position the display via a user interface that controls the positioning mechanism.

Typically display 111 is stored within a storage area (e.g., location 109) when the system is not in use, thus preventing the display from being accidently hit as a passenger moves into, or out of, the vehicle, or otherwise moves about the passenger compartment. When the user wishes to use the display, in one embodiment they simply grip the display (or display handle or handles) and manually move display 111 into position. Alternately, if the display is configured to utilize a positioning system (i.e., a mechanical, electro-mechanical or hydraulic positioning system), then the user simply moves the display to the desired position using the positioning system's interface. This interface may utilize buttons, a touch-screen controller, or other mechanisms to provide the user with the desired level of control over the positioning system. In at least one embodiment in which display movement is controlled by a positioning system, when display 111 or the video source coupled to the display is activated, a controller coupled to the positioning system moves the display into an initial position. From this initial position the user is then able to continue to adjust the position of the display, either manually or using the positioning system.

In FIG. 2, display 111 has been moved, either manually or by controlling a positioning system, into a display position that is compatible with the illustrated position of viewing seat 103. In this embodiment, moving the display into the illustrated position requires that linkage arm 117 be rotated about axis 201, that the pivot mount located at axis 201 be moved within guide track 113, rotation of arm 203 about hinge 205, and rotation of display 111 about hinge 207. Using guide track 113 as well as the various hinged members allows display 111 to be positioned at a comfortable viewing distance 209.

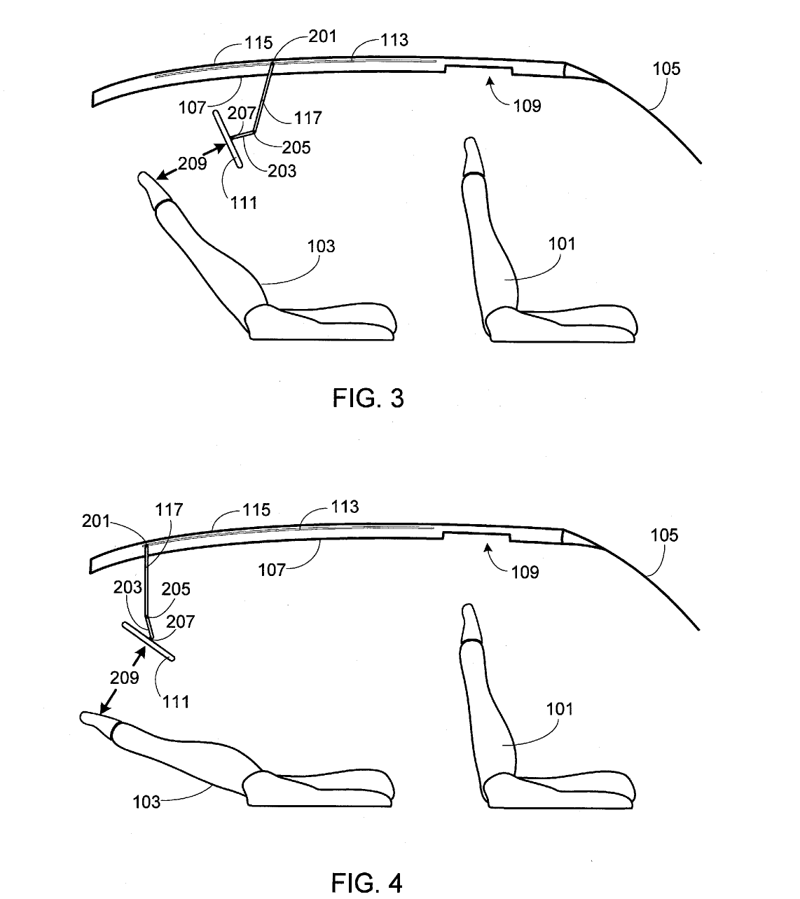

If the user alters the position of seat 103, for example by reclining as shown in FIG. 3, typically the user will adjust the position of display 111, either manually or using the positioning system, thereby maintaining viewing distance 209 within a comfortable range. Thus, for example, for the seat location shown in FIG. 3 typically the user will adjust display 111 by once again rotating linkage arm 117 about axis 201, moving arm 117 within guide track 113, rotating arm 203 about axis 205, and rotating display 111 about axis 207. If the user continues to recline seat 103 as shown in FIG. 4, then typically they would once again move display 111 in order to maintain a reasonable viewing distance 209 between the display panel 111 and the seat 103.

In at least one embodiment in which display 111 is coupled to a positioning system, preferably a system controller coupled to the positioning system automatically returns display 111 to recess 109 (or to a different designated storage area) when the vehicle is turned off. The system can also be set-up to return the display to its storage area (e.g., recess 109) when the car is placed in park. Preferably the user is able to over-ride the system so that display 111 can be left in the viewing position for the occupant of seat 103 even if the car is turned off or placed in park, thus allowing the occupant to continue to utilize the display system.

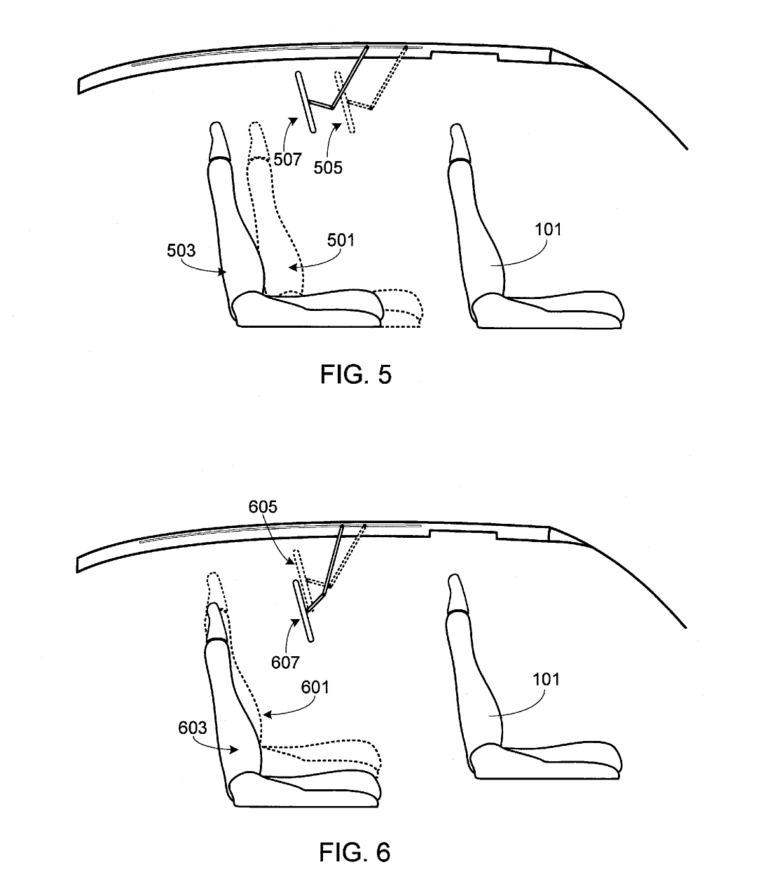

In the previous example, the user alters the position of display 111 in response to adjusting the degree of seat recline. It should be understood that the invention may also be used to compensate for other seat movement. For example, FIG. 5 illustrates that as seat 103 is moved backward from a first position 501, shown in phantom, to a second, final position 503, display 111 may be moved from a first position 505, shown in phantom, to a second, final position 507, thereby retaining a desirable spacing between the user and the display. Similarly, FIG. 6 illustrates that as seat 103 is moved downward from a first position 601, shown in phantom, to a second, final position 603, display 111 may be moved from a first position 605, shown in phantom, to a second, final position 607.

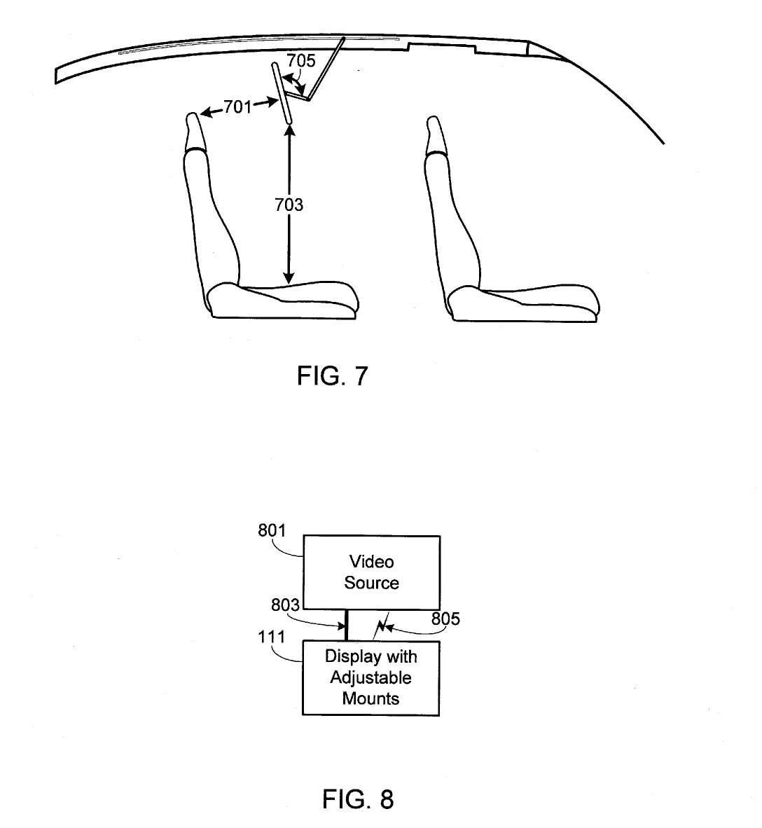

While in the above examples the user was able to adjust the display viewing distance, thereby maintaining the viewing distance within a desirable and acceptable range, it should be understood that the invention may also be used to maintain other display characteristics within an acceptable range. For example and as shown in FIG. 7, in addition to a controlling viewing distance 701, the display viewing height 703 and display viewing angle 705 may also be varied in accordance with user preferences.

As described above, the present invention allows the user to adjust a vehicle's display screen in order to optimize display viewing, regardless of where the user positions their seat. Depending upon how the display is configured, display adjustments can either be performed by the user gripping and moving the display to the desired location utilizing the guide track(s) and linkage arms that couple the display to the vehicle, or the user can make the desired adjustment utilizing a user interface and a positioning system. FIG. 8 illustrates the basic configuration in which the user must manually move the display to the desired location. As shown, display 111 is coupled to a video source 801. Video source 801 may be hard-wired to the display via cabling 803, or coupled via a wireless system 805 using any of a variety of wireless communication protocols (e.g., IEEE 802.11, long term evolution (LTE), Wi-Fi, Bluetooth, WiGig, WirelessHD, etc.). Flat panel display 111 can utilize any of a variety of display technologies (e.g., light-emitting diode (LED), plasma, organic light-emitting diode (OLED), liquid crystal (LCD), thin film transistor LCD (TFT-LCD), field emission display (FED) or other technology). Display 111 may be intended solely for display purposes, i.e., a monitor, or display 111 may be a touch-screen that allows direct user interaction, for example by incorporating capacitive touch technology into the display.

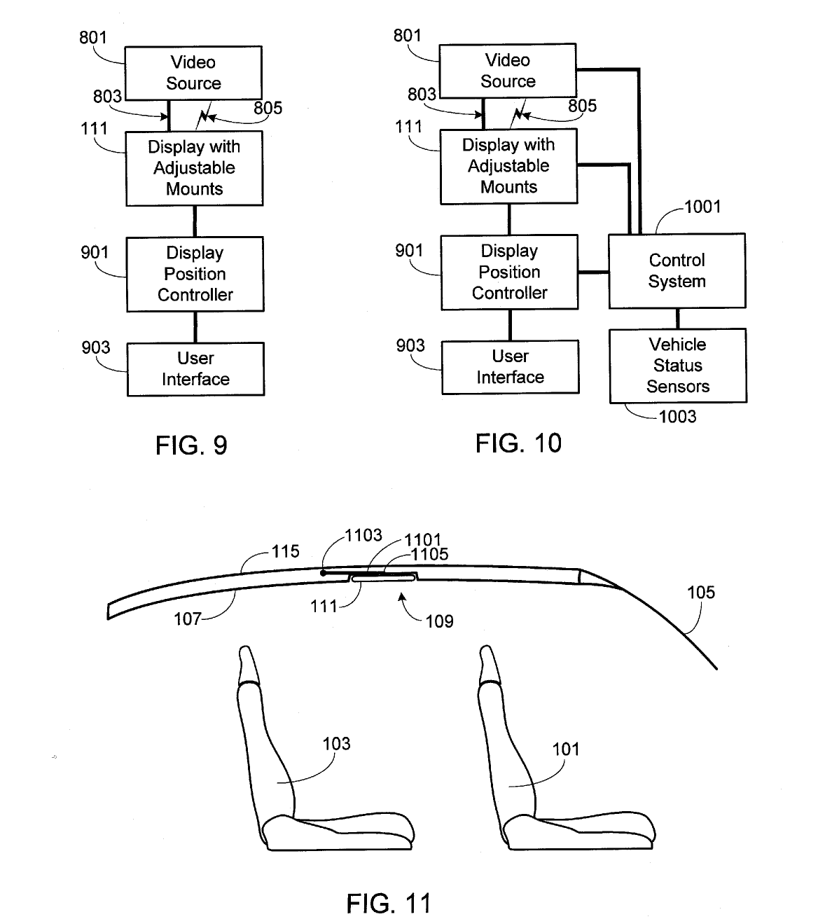

FIG. 9 illustrates an alternate configuration in which the adjustable mounts are coupled to a positioning system 901. Positioning system 901 may utilize an electro-mechanical (e.g., motorized) positioner, a hydraulic positioner or other positioning system to adjust and control the viewing position of display 111. In this configuration, and as described above, the user adjusts the position of display 111 using a user interface 903 that is coupled to positioning system 901. User interface 903 may be a stand-alone interface, or integrated into the vehicle's user interface, and may consist of slide controllers, push buttons, a touch-screen, or other input means.

The embodiment shown in FIG. 10 adds a system controller 1001 to the system shown in FIG. 9. System controller 1001, which includes a control processor, may be a dedicated control system or integrated into another vehicle control system, for example a vehicle management system. As noted above, system controller 1001 may be programmed to automatically deploy display 111 when either video source 801 or display 111 is activated. System controller 1001 may also be programmed to automatically relocate display 111 to its storage position (e.g., position 109) when display 111 is deactivated and/or when video source 801 is deactivated. Note that in the system illustrated in FIG. 10, control system 1001 is also coupled to a vehicle status sensor(s) 1003 that monitors whether or not the vehicle is operating (i.e., turned on) and/or whether or not the vehicle is currently in ‘drive’ or in ‘park’. The system can be configured to utilize this vehicle information to determine when to deploy or store display 111, for example deploying display 111 when the car is turned on or placed into drive and then storing display 111 when the car is turned off or placed into park.

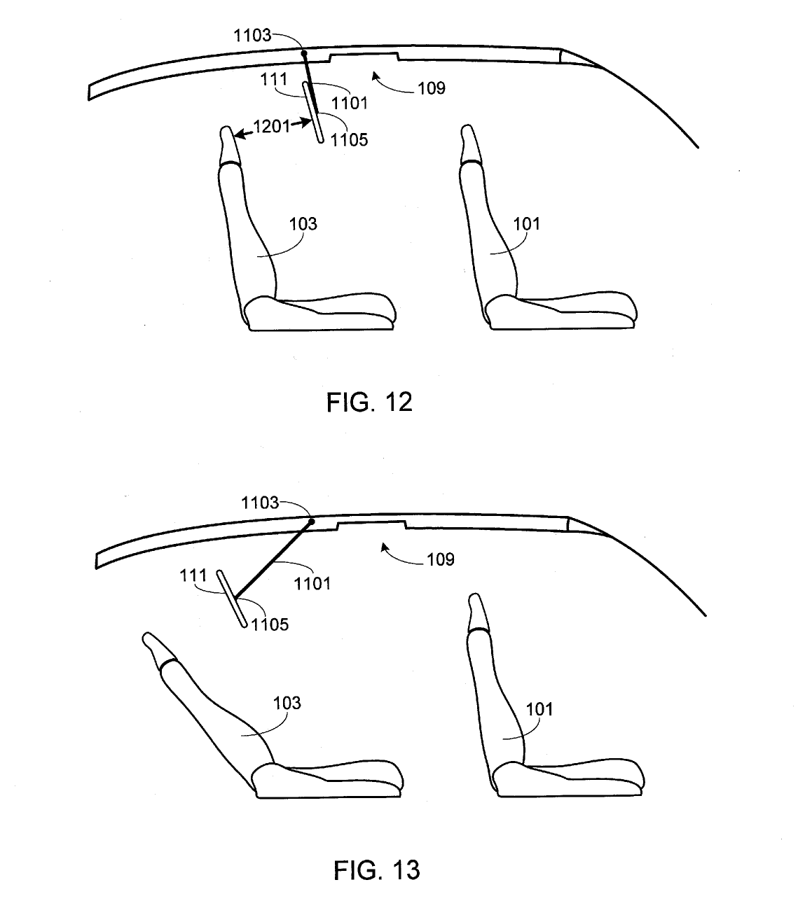

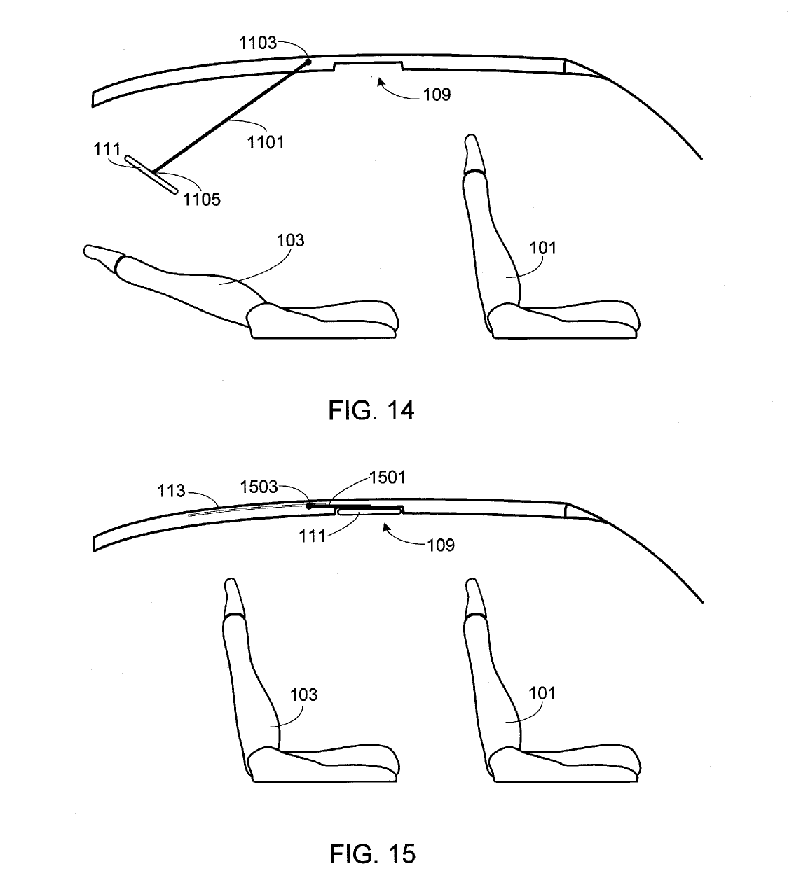

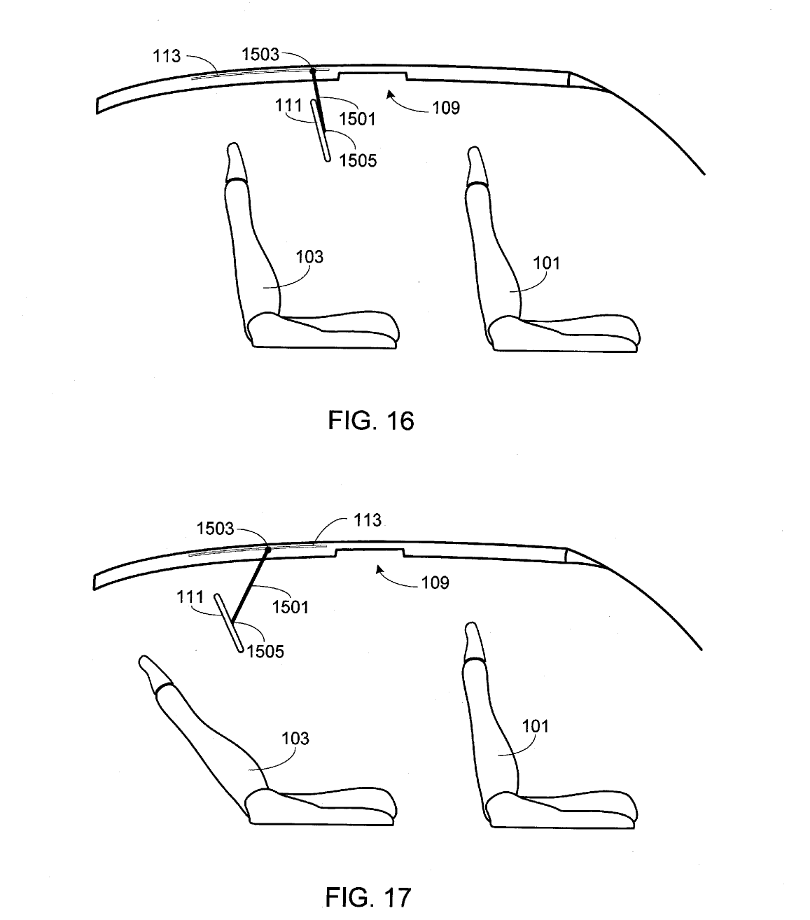

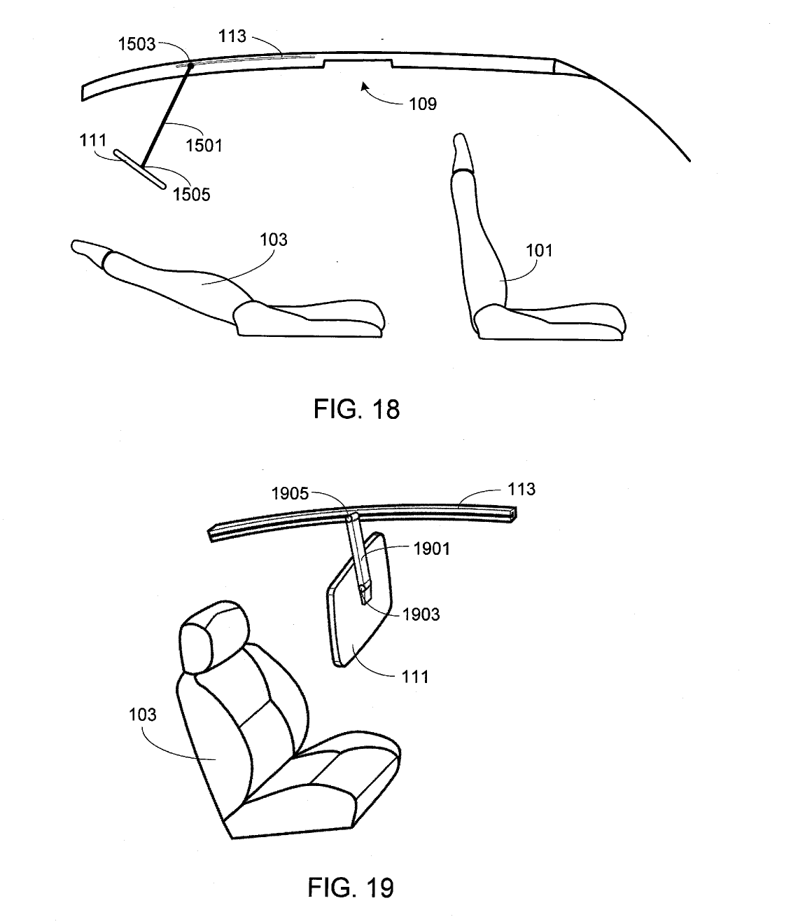

It should be understood that the multi-link display positioning system shown in FIGS. 1-7 is just one possible configuration and that other positioning systems may also be used by the invention. For example, FIGS. 11-14 provide the same views as FIGS. 1-4 but illustrate an alternate linkage system that utilizes a telescoping link 1101 in order to allow the user to adjust viewing distance 1201 or other display characteristic (e.g., display height, display angle). To achieve the desired range of display motion, link 1101 may be pivoted using hinges 1103 and 1105. FIGS. 15-18 illustrate yet another positioning system, this embodiment utilizing a telescoping link 1501 that may be pivoted using hinges 1503 and 1505. Unlike the previous embodiment, however, link 1501 has limited range in order to achieve a greater degree of link stability. To overcome the length limitations of link 1501, link 1501 may be moved within guide track 113.

It will be appreciated that while the embodiments of the display system shown in FIGS. 1-7 and 11-18 are illustrated with a car's rear passenger seat, the display system of the invention is equally applicable to other vehicle seats (e.g., front passenger seat) as well as other types of vehicles (e.g., trains, buses, airplanes, etc.). Additionally, even though in the exemplary embodiments only a single link is visibly coupled to display 111, it should be understood that one or more links may be coupled to the display, and that the linkage assembly may be coupled to the center of the display, to one or both sides of the display, or to multiple locations on the display. To further clarify the invention, FIGS. 19-24 illustrate some exemplary coupling techniques that may be used to couple the linkage assembly to display 111 and to guide track 113. Note that the exemplary coupling techniques shown in these figures may also be used with a multi-link, multi-pivoting assembly as shown in FIGS. 1-7 or with a telescoping link(s) as shown in FIGS. 11-18.

In the embodiment shown in FIG. 19, display 111 is attached to guide track 113 via a single, centrally located arm 1901. Display 111 pivots relative to arm 1901 about hinge 1903, while arm 1901 pivots relative to guide track 113 about hinge 1905.

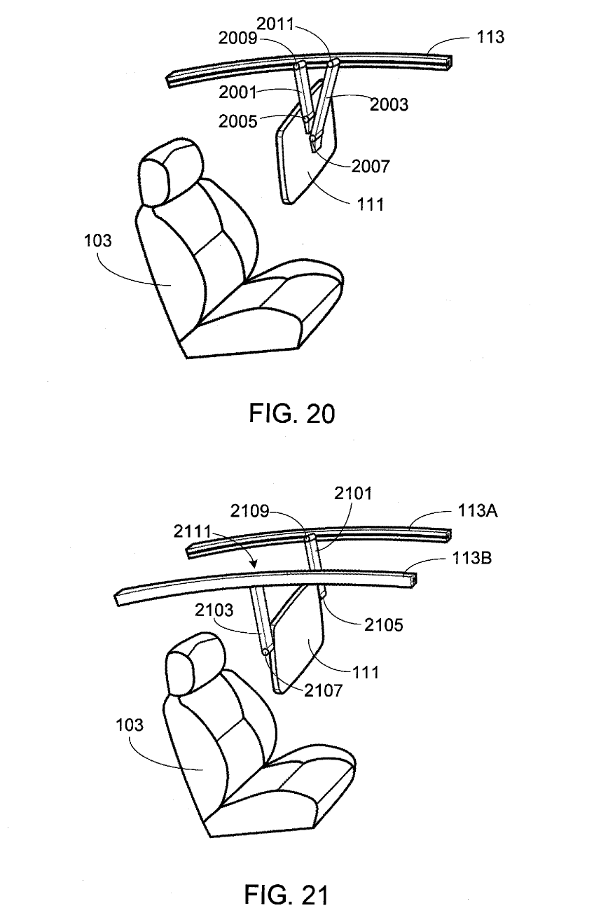

In the embodiment shown in FIG. 20, display 111 is attached to guide track 113 via a pair of centrally located arms 2001 and 2003. Display 111 pivots relative to arm 2001 about hinge 2005 and relative to arm 2003 about hinge 2007. Arm 2001 pivots relative to guide track 113 about hinge 2009 while arm 2003 pivots relative to guide track 113 about hinge 2011.

In the embodiment shown in FIG. 21, display 111 is attached to a pair of guide tracks 113A/113B via a pair of side mounted arms 2101 and 2103. Display 111 pivots relative to arm 2101 about hinge 2105 and relative to arm 2103 about hinge 2107. Arm 2101 pivots relative to guide track 113A about hinge 2109. The hinge coupling at location 2111, not visible in this view, allows arm 2103 to pivot relative to guide track 113B.

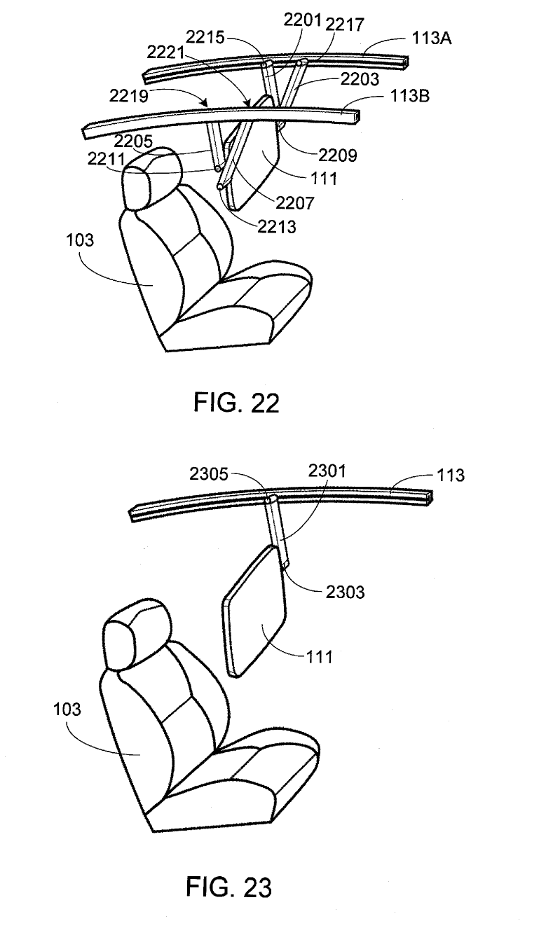

In the embodiment shown in FIG. 22, display 111 is attached to a first guide track 113A via a first pair of side mounted arms 2201 and 2203, and to a second guide track 113B via a second pair of side mounted arms 2205 and 2207. Display 111 pivots relative to arm 2201 about a hinge not visible in this view; pivots relative to arm 2203 about hinge 2209; pivots relative to arm 2205 about hinge 2211; and pivots relative to arm 2207 about hinge 2213. Arm 2201 pivots relative to guide track 113A about hinge 2215; arm 2203 pivots relative to guide track 113A about hinge 2217; arm 2205 pivots relative to guide track 113B about a hinge (not visible in this view) at location 2219; and arm 2207 pivots relative to guide track 113B about a hinge (not visible in this view) at location 2221.

In the embodiment shown in FIG. 23, display 111 is attached to guide track 113 via a single, side mounted arm 2301. Display 111 pivots relative to arm 2301 about hinge 2303, while arm 2301 pivots relative to guide track 113 about hinge 2305.

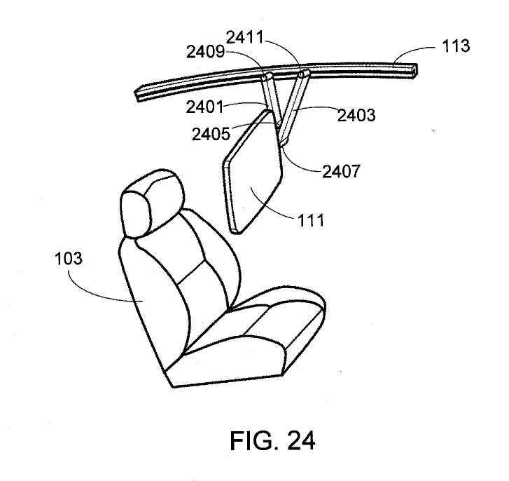

In the embodiment shown in FIG. 24, display 111 is attached to guide track 113 via a pair of side mounted located arms 2401 and 2403. Display 111 pivots relative to arm 2401 about hinge 2405 (partially visible in this view) and relative to arm 2403 about hinge 2407 (partially visible in this view). Arm 2401 pivots relative to guide track 113 about hinge 2409 while arm 2403 pivots relative to guide track 113 about hinge 2411.

It should be understood that the accompanying figures are only meant to illustrate, not limit, the scope of the invention and should not be considered to be to scale.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. An adjustable display system, comprising:
a guide track mounted within and to a vehicle;
a linkage assembly slidably coupled to said guide track, wherein a first portion of said linkage assembly slides within said guide track, and wherein said first portion of said linkage assembly is adjustable within a range of positions in said guide track; and
a display coupled to a second portion of said linkage assembly.

2. The adjustable display system of claim 1, wherein a central portion of a back panel of said display is coupled to said second portion of said linkage assembly.

3. The adjustable display system of claim 1, wherein a side portion of said display is coupled to said second portion of said linkage assembly.

4. The adjustable display system of claim 1, wherein said first portion of said linkage assembly is hingeably coupled to said guide track and is configured to be adjustable and to pivot about a first axis formed at a juncture of said first portion of said linkage assembly and said guide track.

5. The adjustable display system of claim 1, wherein said second portion of said linkage assembly is hingeably coupled to said display and is configured to be adjustable and to pivot about a first axis formed at a juncture of said second portion of said linkage assembly and said display.

6. The adjustable display system of claim 1, wherein said linkage assembly is comprised of at least a first arm and a second arm, wherein said first portion of said linkage assembly is comprised of a first end portion of said first arm and a first end portion of said second arm, and wherein said second portion of said linkage assembly is comprised of a second end portion of said first arm and a second end portion of said second arm.

7. The adjustable display system of claim 6, wherein said first end portion of said first arm is hingeably coupled to said guide track and is configured to be adjustable and to pivot about a first axis formed at a juncture of said first end portion of said first arm and said guide track, and wherein said first end portion of said second arm is hingeably coupled to said guide track and is configured to be adjustable and to pivot about a second axis formed at a juncture of said first end portion of said second arm and said guide track.

8. The adjustable display system of claim 6, wherein said second end portion of said first arm is hingeably coupled to said display and is configured to be adjustable and to pivot about a first axis formed at a juncture of said second end portion of said first arm and said display, and wherein said second end portion of said second arm is hingeably coupled to said display and is configured to be adjustable and to pivot about a second axis formed at a juncture of said second end portion of said second arm and said display.

9. The adjustable display system of claim 1, said linkage assembly further comprising a telescoping link, wherein a link length corresponding to said telescoping link is adjustable, and wherein adjusting said link length controls a separation distance between said guide track and said display.

10. The adjustable display system of claim 1, wherein said linkage assembly is comprised of at least a first arm and a second arm, wherein said first portion of said linkage assembly is comprised of a first end portion of said first arm, wherein a second end portion of said first arm is hingeably coupled to a first end portion of said second arm and is configured to be adjustable and to pivot about a first axis formed at a juncture of said second end portion of said first arm and said first end portion of said second arm, and wherein said second portion of said linkage assembly is comprised of a second end portion of said second arm.

11. The adjustable display system of claim 10, wherein said first end portion of said first arm is hingeably coupled to said guide track and is configured to be adjustable and to pivot about a second axis formed at a juncture of said first end portion of said first arm and said guide track.

12. The adjustable display system of claim 10, wherein said second end portion of said second arm is hingeably coupled to said display and is configured to be adjustable and to pivot about a second axis formed at a juncture of said second end portion of said second arm and said display.

13. The adjustable display system of claim 1, further comprising:
a second guide track mounted within and to said vehicle; and
a second linkage assembly slidably coupled to said second guide track, wherein a first portion of said second linkage assembly slides within said second guide track, and wherein said first portion of said second linkage assembly is adjustable within a second range of positions in said second guide track, and wherein said display is coupled to a second portion of said second linkage assembly.

14. The adjustable display system of claim 1, further comprising:
a user interface; and
a positioning system coupled to said linkage assembly and to said user interface, wherein said user interface accepts display movement instructions, and wherein said positioning system moves said display via said linkage assembly in response to said display movement instructions.

15. The display positioning system of claim 14, said positioning system further comprising an electro-mechanical positioning system.

16. The display positioning system of claim 14, said positioning system further comprising a hydraulic positioning system.

17. The display positioning system of claim 14, further comprising:
a controller coupled to said positioning system; and
a vehicle status monitor coupled to said controller, wherein said vehicle status monitor outputs a display deployment signal upon detection of a first vehicle status and outputs a display storage signal upon detection of a second vehicle status, wherein said controller deploys said display using said positioning system upon receipt of said display deployment signal, and wherein said controller positions said display in a storage position using said positioning system upon receipt of said display storage signal.

18. The display positioning system of claim 17, wherein said first vehicle status corresponds to activation of said vehicle, and wherein said second vehicle status corresponds to de-activation of said vehicle.

19. The display positioning system of claim 17, wherein said second vehicle status corresponds to said vehicle being placed in park.

20. The display positioning system of claim 14, further comprising:
a video source coupled to said display; and
a controller coupled to said positioning system and to said video source, wherein said controller deploys said display using said positioning system when said video source is activated, and wherein said controller positions said display in a storage position using said positioning system when said video source is de-activated.

21. The display positioning system of claim 14, further comprising a controller coupled to said positioning system and to said display, wherein said controller deploys said display using said positioning system when said display is activated, and wherein said controller positions said display in a storage position using said positioning system when said display is de-activated.
